(19) United States
(12) Patent Application Publication
(10) Pub. No.: US 2026/0304285 A1
(43) Pub. Date: Oct. 1, 2026

(54) COMMUNICATION DEVICE, CONTROL METHOD, AND STORAGE MEDIUM

(71) Applicant: HONDA MOTOR CO., LTD., Tokyo (JP)

(72) Inventor: Kosei Tsushima, Tokyo (JP)

(21) Appl. No.: 19/561,742

(22) Filed: Mar. 10, 2026

(30) Foreign Application Priority Data
Mar. 27, 2025 (JP) 2025-053253

(51) Int. Cl. H04W 40/22; H04W 76/50; H04W 84/12

(52) U.S. Cl. CPC H04W 40/22; H04W 76/50; H04W 84/12

(57) ABSTRACT

A communication device is provided in a mobile object, and includes, as outside-communication interfaces for communication with the outside of the mobile object, at least one cellular communication unit that performs cellular communication and a wireless LAN communication unit that performs wireless LAN communication. The communication device includes: a plurality of virtual routers that determines whether to route a communication to the cellular communication unit, or to route a communication to the wireless LAN communication unit; and a communication control section that has a normal-time mode and an emergency-time mode. The communication control section differentiates ways of routing in the normal-time mode and the emergency-time mode from each other by controlling routing by the virtual routers. In the emergency-time mode, the communication control section performs control in such a manner that a specified one of the outside-communication interfaces performs communication.

### INCORPORATION BY REFERENCE

The present application claims priority under 35 U.S.C. § 119 to Japanese Patent Application No. 2025-053253 filed on Mar. 27, 2025. The content of the application is incorporated herein by reference in its entirety.

### BACKGROUND OF THE INVENTION

### Field of the Invention

The present invention relates to a communication device, a control method, and a storage medium.

### Description of the Related Art

A communication device provided in a mobile object for performing cellular communication and wireless LAN communication has conventionally been known (for example, see the specification of U.S. Pat. No. 8,538,373). The communication device according to the specification of U.S. Pat. No. 8,538,373 discloses a technique of periodically sending an emergency signal after a switch is placed in an emergency mode through a user operation.

However, in case of emergency, during which highly accurate communication is necessary between a mobile object and the outside, conventional techniques may not offer appropriate communication.

An object of the present invention, which has been made in view of the above-described circumstances, is to provide a communication device, a control method, and a storage medium that enable communication to be performed with appropriate accuracy in case of emergency.

### SUMMARY OF THE INVENTION

To achieve the objective, an aspect of the present invention is a communication device that is provided in a mobile object, and that includes, as outside-communication interfaces for communication with the outside of the mobile object, at least one cellular communication unit that performs cellular communication and a wireless LAN communication unit that performs wireless LAN communication. The communication device includes: a plurality of virtual routers that determines whether to route a communication to the cellular communication unit, or to route a communication to the wireless LAN communication unit; and a communication control section that has a normal-time mode and an emergency-time mode. The communication control section differentiates ways of routing in the normal-time mode and the emergency-time mode from each other by controlling routing by the virtual routers. In the emergency-time mode, the communication control section performs control in such a manner that only a specified one of the outside-communication interfaces performs communication.

The present invention enables communication to be performed with appropriate accuracy in case of emergency.

### BRIEF DESCRIPTION OF THE DRAWINGS

FIG. 1 schematically shows a configuration of a communication system;

FIG. 2 schematically shows an example of system components included in the communication system according to a first embodiment;

FIG. 3 is an image diagram showing packet routing by a TCU in the first embodiment;

FIG. 4 is a flowchart showing operation of the TCU;

FIG. 5 is a flowchart showing details of operation of the TCU in a normal-time mode;

FIG. 6 schematically shows an example of system components included in a communication system according to a second embodiment; and

FIG. 7 is an image diagram showing packet routing by a TCU in the second embodiment.

### DETAILED DESCRIPTION OF THE INVENTION

### First Embodiment

### 1. Configuration

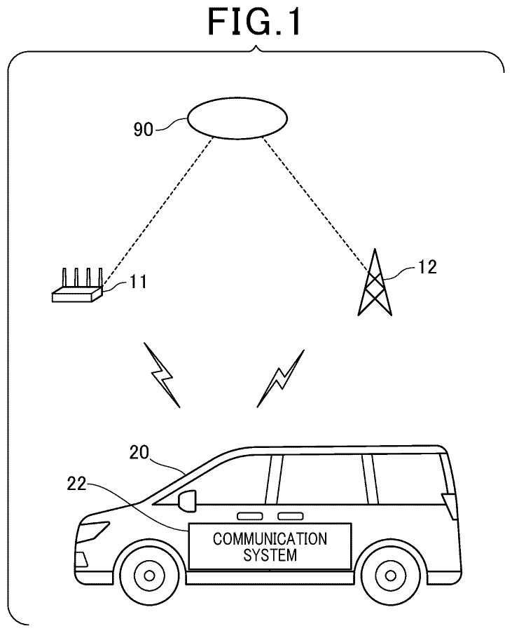

FIG. 1 schematically shows a configuration of a communication system 22. The communication system 22 is provided in a mobile object 20.

The mobile object 20 is equipment capable of moving. The mobile object 20 is, for example, a vehicle such as an automobile, such as a bus, or a train. A vehicle is an example of transport equipment. The mobile object 20 may be any one of various aircrafts and the like including unmanned aircrafts.

The communication system 22 has functions of performing cellular communication and wireless local area network (LAN) communication. The communication system 22 can communicate, via a wireless relay device 11 and a wireless base station 12, with communication equipment connected to a communication network 90. The communication network 90 includes a computer network, such as the Internet, as well as a cellular communication network and the like.

The wireless relay device 11, the wireless base station 12, and the communication equipment connected to the communication network 90 are examples of the outside of the mobile object 20.

The wireless base station 12 is a cellular communication base station that supports one or more cellular communication schemes. The cellular communication scheme supported by the wireless base station 12 may be, for example, a communication scheme used in a mobile communication system, such as the fourth generation mobile communication system (4G) or the fifth generation mobile communication system (5G). The wireless base station 12 relays a communication between a communication device in the communication system 22 and the communication equipment connected to the communication network 90.

The wireless relay device 11 has a function of relaying a wireless LAN communication. For example, the wireless relay device 11 has a wireless LAN access point function. The wireless relay device 11 relays a communication between a communication device in the communication system 22 and the communication equipment connected to the communication network 90.

The mobile object 20 in the present embodiment is a vehicle, and the communication system 22 includes a plurality of communication devices connected to a communication network in the vehicle. The plurality of communication devices connected to the communication network in the vehicle includes, for example, electronic control units (ECUs) included in the vehicle.

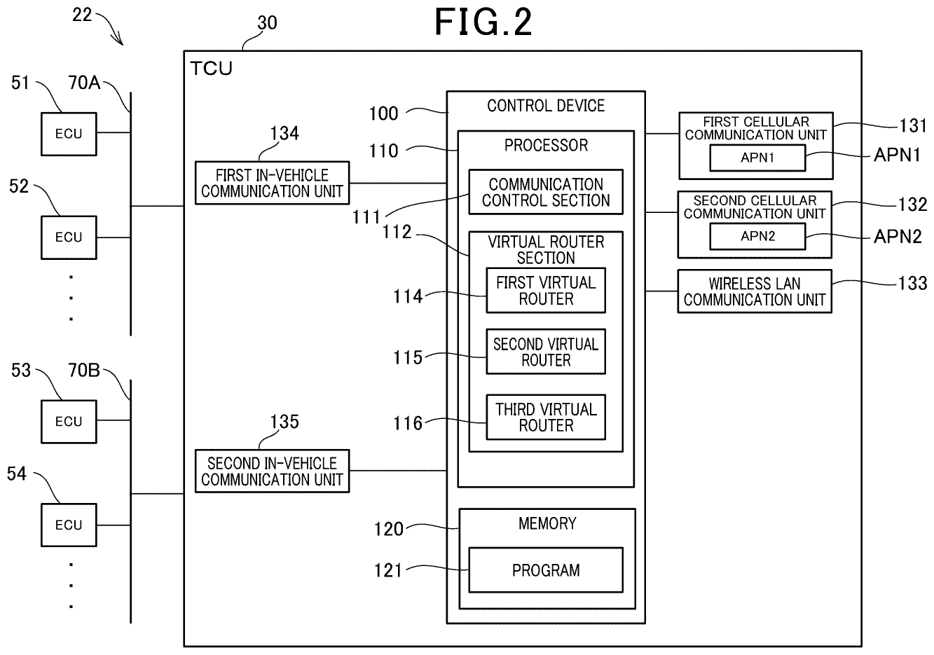

FIG. 2 schematically shows an example of system components included in the communication system 22.

The communication system 22 includes a telematics control unit (TCU) 30, in-vehicle communication networks 70A, 70B, and a plurality of ECUs including ECUs 51, 52 connected to the in-vehicle communication network 70A and ECUs 53, 54 connected to the in-vehicle communication network 70B.

The in-vehicle communication network 70A includes, for example, an Ethernet(R) bus and an Ethernet(R) hub.

The in-vehicle communication network 70B is, for example, a virtual local area network (LAN) configured by the TCU 30.

The TCU 30 is an example of a communication device. The TCU 30 is a so-called telematics control unit.

The TCU 30 includes a control device 100, a first cellular communication unit 131, a second cellular communication unit 132, and a wireless LAN communication unit 133. The first cellular communication unit 131 and the second cellular communication unit 132 are examples of a cellular communication unit.

The first cellular communication unit 131, the second cellular communication unit 132, and the wireless LAN communication unit 133 are examples of an outside-communication interface.

The first cellular communication unit 131 and the second cellular communication unit 132 perform cellular communication with the outside of the mobile object 20 in accordance with control by the control device 100. The first cellular communication unit 131 is assigned APN1 that is an access point name, and the second cellular communication unit 132 is assigned APN2 that is an access point name. APN1 is an example of specified one access point name.

Thus, the TCU 30 is capable of handling a plurality of cellular communications associated with different access point names.

The wireless LAN communication unit 133 performs wireless LAN communication with the outside of the mobile object 20 in accordance with control by the control device 100.

Here, a characteristic of the wireless LAN communication in the mobile object 20 is described.

Generally, standards for wireless LAN communication are updated in a much shorter cycle than the lifetime of the vehicle. In the TCU 30, a virtual router section 112 determines whether to route a communication to the wireless LAN communication unit 133. Accordingly, the TCU 30 is characterized in that when the standards for wireless LAN communication are changed, the virtual router section 112 is easily updated, without hardware of the TCU 30 being updated, and thus a latest wireless LAN communication can be handled.

Accordingly, control that prioritizes wireless LAN communication can be realized throughout the lifetime of the vehicle. Thus, since wireless LAN communication can be used throughout the lifetime of the vehicle, costs for communication in the vehicle can be reduced.

On the other hand, in wireless LAN communication, security is low and the immediacy of communications is poor in general, compared to cellular communication.

Returning to the description of the TCU 30, the TCU 30 further includes a first in-vehicle communication unit 134 and a second in-vehicle communication unit 135.

The first in-vehicle communication unit 134 is an input-output interface connected to the in-vehicle communication network 70A described above. The first in-vehicle communication unit 134 performs wired communication mutually with each ECU and other equipment such as a relay device via the in-vehicle communication network 70A.

The second in-vehicle communication unit 135 is a communication device that performs wireless communication, for example, in conformity with the communication standards for Wi-Fi(R)-based short-range wireless communication. The second in-vehicle communication unit 135 performs wireless communication mutually with each ECU and other equipment such as a relay device via the in-vehicle communication network 70B that is configured in the vehicle and conforms with the wireless communication standards. Each ECU and other equipment such as a relay device will be referred to as in-vehicle equipment as appropriate.

The control device 100 includes a processor 110, such as a central processing unit (CPU) or a microprocessor unit (MPU), a memory 120, and interface circuitry for connection with other devices and sensors.

The memory 120 is a storage device that stores a program and data. The memory 120 stores a program 121 and data to be processed by the processor 110. The memory 120 has a non-volatile storage area. Moreover, the memory 120 may have a volatile storage area, which may constitute a work area for the processor 110. The memory 120 is configured by using, for example, a read only memory (ROM) and a random access memory (RAM).

The program 121 is a program for causing the processor 110 to function as functional sections. The processor 110 functions as a communication control section 111 and the virtual router section 112 by reading and executing the program 121 stored in the memory 120.

The communication control section 111 performs wired communication with the in-vehicle equipment via the first in-vehicle communication unit 134.

The communication control section 111 performs wireless communication with the in-vehicle equipment via the second in-vehicle communication unit 135.

The communication control section 111 performs cellular communication with the outside of the mobile object 20 via the first cellular communication unit 131 or the second cellular communication unit 132.

The communication control section 111 performs wireless LAN communication with the outside of the mobile object 20 via the wireless LAN communication unit 133.

More specifically, the communication control section 111 receives packets from in-vehicle equipment via the first in-vehicle communication unit 134 or the second in-vehicle communication unit 135, and transmits the received packets to the outside via the first cellular communication unit 131, the second cellular communication unit 132, or the wireless LAN communication unit 133. The packets will be described later.

The communication control section 111 controls routing by the virtual router section 112. More specifically, the communication control section 111 controls routing, by setting a routing table that indicates how the virtual router section 112 routes each packet.

The communication control section 111 inputs, based on the routing table, received packets into individual virtual routers configured in the virtual router section 112.

The communication control section 111 configures a virtual router in the virtual router section 112, and deletes a configured virtual router.

The virtual router section 112 includes virtual routers that determine whether to route a communication to the first cellular communication unit 131, to route a communication to the second cellular communication unit 132, or to route a communication to the wireless LAN communication unit 133.

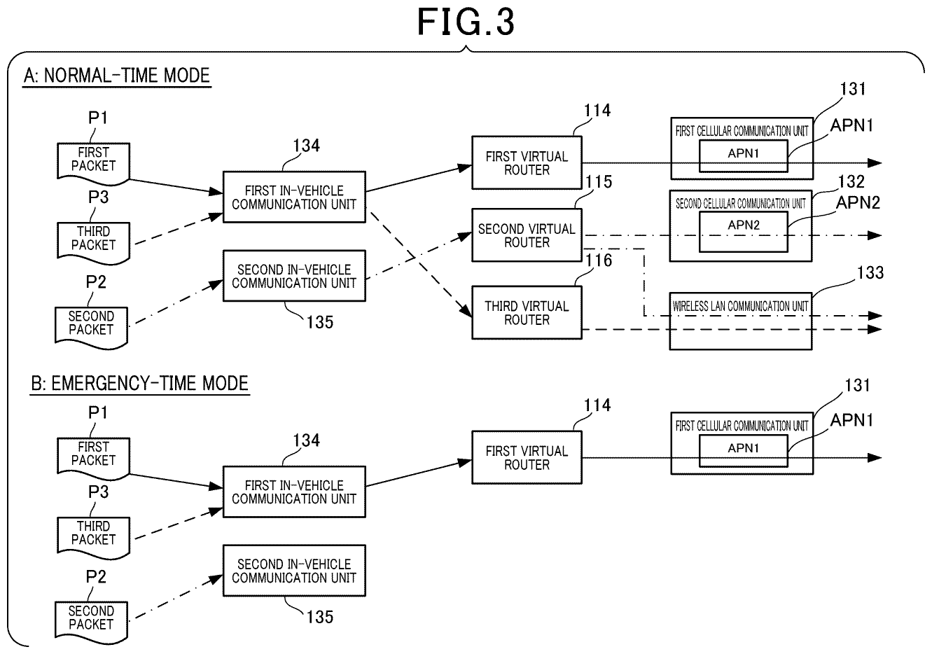

FIG. 3 is an image diagram showing packet routing by the TCU 30.

FIG. 3 shows an image A in a normal-time mode and an image B in an emergency-time mode.

Hereinafter, packets and the virtual routers are described with reference to FIGS. 2 and 3.

First, packets are described.

In the present embodiment, three types of packets, a first packet P1, a second packet P2, and a third packet P3, are illustrated as packets received from equipment mounted in the mobile object 20.

The first packet P1 is a packet received through wired communication via the first in-vehicle communication unit 134.

The first packet P1 is a packet related to a first service. The first service is a service involving at least any one of high-immediacy and high-security-level requirements.

The first packet P1 is data on a vehicle control system, such as data related to travel control of the mobile object 20. More specifically, the first packet P1 includes data on a control system for a driving device, such as an engine, an error log, data indicating a vehicle state, or the like. The first packet P1 may include data related to position information on the mobile object 20.

The second packet P2 is a packet received through wireless communication via the second in-vehicle communication unit 135.

The second packet P2 is a packet related to a second service. The second service is a service involving at least any one of the requirement of high immediacy, though lower than that of the first service, and the requirement of a high security level, though lower than that of the first service.

The second packet P2 is data, among mobile object 20-related data and the like, that requires at least any one of intermediate immediacy and an intermediate security level. The second packet P2 is, for example, data related to a service that requires relatively high immediacy but requires an intermediate security level.

The third packet P3 is a packet received through wired communication via the first in-vehicle communication unit 134.

The third packet P3 is a packet related to a third service. The third service is a service involving at least any one of lower required immediacy than those of the first service and the second service, and a lower required security level than those of the first service and the second service. The third packet P3 is, for example, data for in-vehicle infotainment (IVI) or data related to at least any one of entertainment services.

Note that, as an example, each service is identified based on a port number and the source of a packet.

Here, the virtual routers configured in the virtual router section 112 are described.

The virtual router section 112 includes a first virtual router 114, a second virtual router 115, and a third virtual router 116. The first virtual router 114 is an example of a specified virtual router.

The first virtual router 114 is a virtual router that routes a communication of first packets P1.

It is desirable that the first virtual router 114 be used for routing of data related to the service that requires at least any one of high immediacy and a high security level.

For example, it is desirable that the first virtual router 114 be used for routing of data on the vehicle control system, such as data related to travel control of the mobile object 20. In other words, it is desirable that the first virtual router 114 be used for routing of first packets P1 corresponding to the first service.

The first virtual router 114 is a virtual router that is associated with APN1 of the first cellular communication unit 131 and that routes a communication only to the first cellular communication unit 131. Accordingly, the first virtual router 114 associates an inputted packet with APN1 and inputs the packet into the first cellular communication unit 131.

Here, the first cellular communication unit 131 transmits the inputted first packet P1 after translating the local IP address thereof into a global IP address assigned from a communication carrier that provides APN1. Thus, the first packet P1 is transmitted to a communication path associated with APN1.

The second virtual router 115 is a virtual router that routes a communication of second packets P2.

The second virtual router 115 is a virtual router that is associated with APN2 of the second cellular communication unit 132 and that routes a communication to the second cellular communication unit 132 or the wireless LAN communication unit 133.

Based on the preset routing table, the second virtual router 115 associates a packet to be routed to the second cellular communication unit 132, among inputted second packets P2, with APN2 and inputs the packet into the second cellular communication unit 132, and inputs a packet to be routed to the wireless LAN communication unit 133, among the inputted second packets P2, into the wireless LAN communication unit 133.

Here, the second cellular communication unit 132 translates the local IP address of the inputted packet into a global IP address assigned from a communication carrier that provides APN2.

Accordingly, when second packets P2 are set, by the routing table, to be routed to the second cellular communication unit 132, the second packets P2 are transmitted to a communication path associated with APN2. When second packets P2 are set, by the routing table, to be routed to the wireless LAN communication unit 133, the second packets P2 are transmitted to the wireless relay device 11 after the local IP address of each second packet P2 is translated into an IP address assigned to the wireless LAN communication unit 133.

Since data communication is performed through wireless LAN communication in some cases, depending on routing by the second virtual router 115, it is desirable that the second virtual router 115 be used for routing of data related to a service that requires relatively high immediacy but requires an intermediate security level. In other words, it is desirable that the second virtual router 115 be used for routing of second packets P2 corresponding to the second service.

The third virtual router 116 is a virtual router that routes a communication of third packets P3.

The third virtual router 116 inputs a third packet P3 to be routed to the wireless LAN communication unit 133 into the wireless LAN communication unit 133. Here, the third packet P3 is transmitted to the wireless relay device 11 after the local IP address thereof is translated into an IP address assigned to the wireless LAN communication unit 133.

Since the third virtual router 116 routes a communication only to the wireless LAN communication unit 133, it is desirable that the third virtual router 116 be used for routing of data that requires relatively low immediacy and requires a relatively low security level. In other words, it is desirable that the third virtual router 116 be used for routing of third packets P3 corresponding to the third service.

As described above, the virtual router section 112 determines which one of the first cellular communication unit 131, the second cellular communication unit 132, and the wireless LAN communication unit 133 communications of first packets P1, second packets P2, and third packets P3 received by the communication control section 111 are to be routed.

In cases of the normal-time mode, the communication control section 111 performs control such that cellular communication and wireless LAN communication are performed in parallel, by controlling routing in the virtual router section 112 configured as described above.

In other words, the communication control section 111 enables wireless LAN communication to be performed while cellular communication is being performed. Thus, when wireless LAN communication is possible, wireless LAN communication can be performed even if cellular communication can be performed. Accordingly, the amount of communication through cellular communication can be reduced. Thus, costs for communication can be reduced.

In the normal-time mode, when a predetermined wireless LAN prioritization event is detected, the communication control section 111 in the present embodiment performs control for communication to be performed through wireless LAN communication in preference to cellular communication, by controlling routing by the virtual router section 112, that is, by changing the routing table.

When a predetermined wireless LAN prioritization event is detected, the communication control section 111 performs control for communication to be performed through wireless LAN communication in preference to cellular communication, by controlling routing by the second virtual router 115.

Wireless LAN prioritization events include an event indicating that cellular communication falls in a poorer communication state. When the mobile object 20 is a vehicle, wireless LAN prioritization events include at least one of an event indicating that the speed of the vehicle becomes a predetermined first speed value or less, and an event indicating that an ignition power supply of the vehicle is turned off. The first speed value may be, for example, any speed value in a range of 10 km/h to 30 km/h inclusive.

In the normal-time mode, when a predetermined cellular prioritization event is detected, the communication control section 111 in the present embodiment performs control for communication to be performed through cellular communication in preference to wireless LAN communication, by controlling routing by the virtual router section 112.

When a cellular prioritization event is detected, the communication control section 111 performs control for communication to be performed through cellular communication in preference to wireless LAN communication, by controlling routing by the second virtual router 115, that is, by changing the routing table.

Cellular prioritization events include an event indicating that wireless LAN communication falls in a poorer communication state. When the mobile object 20 is a vehicle, cellular prioritization events include at least one of an event indicating that the speed of the vehicle becomes a predetermined second speed value or more, and an event indicating that the ignition power supply of the vehicle is turned on. The second speed value may be, for example, a speed value of 40 km/h or more.

The communication control section 111 may determine whether each of the communication state in cellular communication and the communication state in wireless LAN communication is good or poor, based on at least any one of received signal strength indicator (RSSI), communication bandwidth, transmission speed, and the like.

Note that when neither a cellular prioritization event nor a wireless LAN prioritization event occurs in the normal-time mode, the routing table with regard to the second virtual router 115 is set as follows. Specifically, the routing table is set such that second packets P2 are routed to an outside-communication interface supporting either cellular communication or wireless LAN communication.

In the normal-time mode, the communication control section 111 controls routing by the virtual router section 112, whereby a communication related to travel control of the mobile object 20, that is, a communication of first packets P1 related to the first service is routed to APN1 of the first cellular communication unit 131 in preference to the wireless LAN communication unit 133. Thus, a communication related to travel control of the vehicle is performed, with high immediacy or a high security level ensured, compared to other routing.

In the normal-time mode, the communication control section 111 controls routing by the virtual router section 112, whereby a communication other than communications related to travel control of the vehicle, that is, a communication of third packets P3 related to the third service is routed to the wireless LAN communication unit 133 in preference to the first cellular communication unit 131. Although security in wireless LAN communication is lower than in cellular communication, security issues are not significant even if wireless LAN communication is used for communications to use the third service.

By separating virtual routers according to services as described above, it is made easier to manage communications, according to the characteristics of the services, as well as requests.

Next, the emergency-time mode shown in the image B of FIG. 3 is described.

In the emergency-time mode, the communication control section 111 performs communication only through cellular communication corresponding to the specified one access point name.

In the emergency-time mode, the communication control section 111 stops the outside-communication interfaces except the first cellular communication unit 131 that performs cellular communication corresponding to APN1. In other words, in the emergency-time mode, the communication control section 111 stops the second cellular communication unit 132 and the wireless LAN communication unit 133.

Note that in the emergency-time mode, since the second cellular communication unit 132 as an outside-communication interface is stopped, network paths associated with APN2 are disabled. An outside-communication interface being stopped by the communication control section 111 includes any one of the outside-communication interface being shut down, and network paths associated with the outside-communication interface being disabled. An outside-communication interface being stopped means that control is performed in such a manner that communications associated with the outside-communication interface will not be performed.

Thus, since resources used for communication between the mobile object 20 and the outside are reduced, costs for communication are reduced.

Moreover, in the emergency-time mode, the communication control section 111 deletes the second virtual router 115 and the third virtual router 116, except the first virtual router 114 that routes cellular communications associated with APN1.

Thus, in the mobile object 20, packets transmitted from in-vehicle equipment are inputted into the first in-vehicle communication unit 134 or the second in-vehicle communication unit 135, and are stopped without being routed at a stage where the packets are received by the communication control section 111. Accordingly, since resources used for communication are reduced, costs for communication are reduced.

In summary, in the emergency-time mode, by the communication control section 111, only packets associated with APN1 are transmitted to the outside. In other words, only first packets P1 related to the first service are transmitted to the outside. Thus, in the emergency-time mode, resources used for communication are limited to only those for cellular communication corresponding to APN1. Accordingly, costs for communication are reduced, and accuracy in communication is enhanced.

### 2. Operation

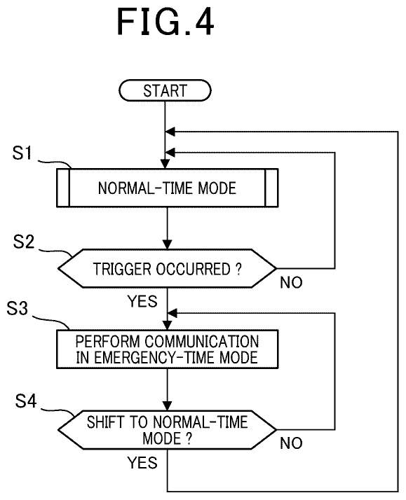

FIG. 4 is a flowchart showing operation of the TCU.

First, the control device 100 performs control in the normal-time mode (step S1). Step S1 is an example of a normal-time control step.

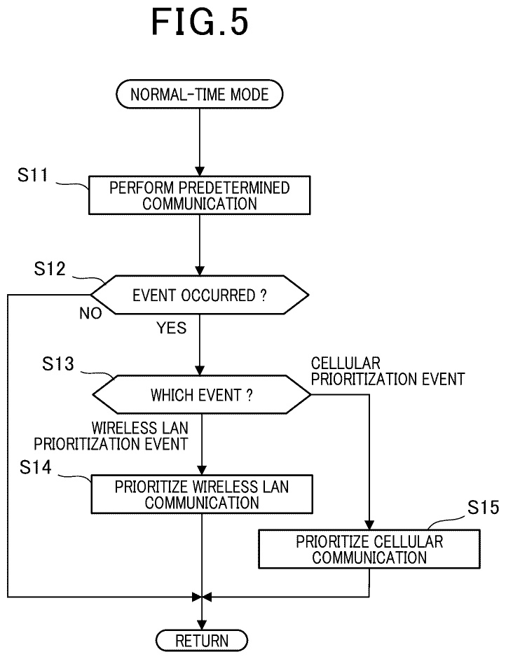

Here, operation of the TCU 30 in the normal-time mode is described with reference to FIG. 5.

FIG. 5 is a flowchart showing the operation of the TCU 30 in the normal-time mode.

In the normal-time mode, first, the communication control section 111 performs predetermined communication (step S11). The predetermined communication is to control routing of each packet, based on the routing table determined at the time of step S11, without making any particular change in the routing table.

Next, the communication control section 111 determines whether an event occurs (step S12) and, when no event occurs (step S12: NO), moves to step S2 shown in FIG. 4, which will be described later.

When an event occurs (step S12: YES), the communication control section 111 determines which the occurring event is, a wireless LAN prioritization event or a cellular prioritization event (step S13).

When the event is a wireless LAN prioritization event (step S13: WIRELESS LAN PRIORITIZATION EVENT), the communication control section 111 increases services for which packets, among second packets P2, are to be routed to the wireless LAN communication unit 133 (step S14).

Here, for example, the communication control section 111 may change the routing table in such a manner that packets associated with one or more services, among services for which packets are set to be routed to the second cellular communication unit 132, will be routed to the wireless LAN communication unit 133. In other words, here, the routing table is changed with regard particularly to the second virtual router 115. Thus, when preferential use of wireless LAN communication becomes possible, wireless LAN communication can be prioritized over cellular communication. Accordingly, costs for communication can be reduced.

In contrast, when the event is a cellular prioritization event (step S13: CELLULAR PRIORITIZATION EVENT), the communication control section 111 increases services for which packets, among second packets P2, are to be routed to the second cellular communication unit 132 (step S15).

In the cellular prioritization event, for example, the communication control section 111 reduces services for which packets are to be routed to the wireless LAN communication unit 133. For example, the communication control section 111 may change the routing table in such a manner that packets associated with one or more services, among services for which packets are set to be routed to the wireless LAN communication unit 133, will be routed to the second cellular communication unit 132. In other words, here, the routing table is changed with regard particularly to the second virtual router 115.

Here, the cellular prioritization event in the normal-time mode is described in detail. As an example, among services for which packets are set to be routed to the wireless LAN communication unit 133, the communication control section 111 may preferentially select at least one or some services requiring a higher security level, and may change the routing table in such a manner that packets associated with the selected service or services will be routed to the second cellular communication unit 132.

Among services for which packets are set to be routed to the wireless LAN communication unit 133, the communication control section 111 may preferentially select at least one or some services requiring higher immediacy, and may change the routing table in such a manner that packets associated with the selected service or services will be routed to the second cellular communication unit 132.

Note that requirement information, which indicates a required security level and required immediacy to use a service, is stipulated and set beforehand for each service. The communication control section 111 may identify a service for which packets are to be routed to one of the outside-communication interfaces, by referring to the requirement information.

Returning to the description of FIG. 4, after step S1 ends, the communication control section 111 determines whether a trigger to shift from the normal-time mode to the emergency-time mode occurs (step S2) and, when no trigger occurs, moves the processing back to step S1.

The trigger corresponds to a case of emergency, that is, a case where a situation arises in which specific data needs to be transmitted with high accuracy. Communication with high accuracy includes at least one of the fact that communication has high immediacy, the fact that it is highly reliable that data can continue to be transmitted without interruption, the fact that it is highly probable that data is correctly transmitted, and the fact that there is a small number of errors in transmitted data. In the first embodiment, the specific data is first packets P1.

The trigger is a case where the communication control section 111 receives an instruction to shift to the emergency-time mode. Three specific examples, as types of trigger, are described.

A first type of trigger is a case where an instruction to shift to the emergency-time mode is received from in-vehicle equipment, such as each ECU included in the mobile object 20. Such cases include, for example, a case where there occurs such a failure that the engine of the mobile object 20 cannot be started, a case where a predetermined user or object is left inside the mobile object 20, a case where the mobile object 20 is being used by a suspicious person, and a case where the mobile object 20 is in any other abnormal state.

The predetermined user is, for example, a child, and the predetermined object is, for example, a pet.

The case where the mobile object 20 is being used by a suspicious person is, for example, a case where a traveling-related drive source is started through a non-normal procedure.

An example of the mobile object 20 being in any other abnormal state is a case where the mobile object 20 is being transported in a state where the drive source of the mobile object 20 is not started.

An example of the mobile object 20 being in any other abnormal state may include a case where the drive source of the mobile object 20 is not started, and a battery that is the power supply of the TCU 30 is started.

An example of the mobile object 20 being in any other abnormal state is a case where the amount of data traffic in the TCU 30 indicates an abnormal value. Such a case corresponds to a case where some error occurs in a system in the mobile object 20, or a case where the mobile object 20 is hit by a cyberattack. Such a case is, for example, a case where data related to a service that is not used in normal times is being communicated although the engine of the mobile object 20 is not started.

A second type of trigger is a case where an instruction to shift to the emergency-time mode is received from an external server (not shown) that communicates with the mobile object 20. Such a case is a case where a server of a management company involved with the mobile object 20 (for example, a company involved with an insurance of the vehicle, a company that assists the vehicle in traveling) determines that the mobile object 20 is in emergency.

A third type of trigger is a case where an instruction to shift to the emergency-time mode is received from a user using the mobile object 20. The user can issue the instruction to shift to the emergency-time mode, through operation of in-vehicle equipment of the mobile object 20, or operation of a mobile terminal that communicates with the mobile object 20.

When the communication control section 111 determines that a trigger occurs (step S2: YES), the communication control section 111 performs communication in the emergency-time mode (step S3). Step S3 is an example of an emergency-time control step.

In step S3, specifically, the communication control section 111 routes a communication exclusively to the first cellular communication unit 131 corresponding to APN1, stops the second cellular communication unit 132 corresponding to APN2 and the wireless LAN communication unit 133, allows the first virtual router 114 to operate, and deletes the second virtual router 115 and the third virtual router 116.

Next, the communication control section 111 determines whether to shift to the normal-time mode (step S4) and, when determining not to shift to the normal-time mode (step S4: NO), moves the processing back to step S3 and continues the control in the emergency-time mode.

When the communication control section 111 determines to shift to the normal-time mode (step S4: YES), the communication control section 111 moves the processing back to step S1.

The case where the communication control section 111 determines to shift to the normal-time mode is a case where an instruction to shift to the normal-time mode is received from in-vehicle equipment, the external server, the mobile terminal used by the user, or the like.

The TCU 30 terminates the processing shown in FIGS. 4 and 5, by the power supply of the TCU 30 being turned off.

### Second Embodiment

### 3. Configuration

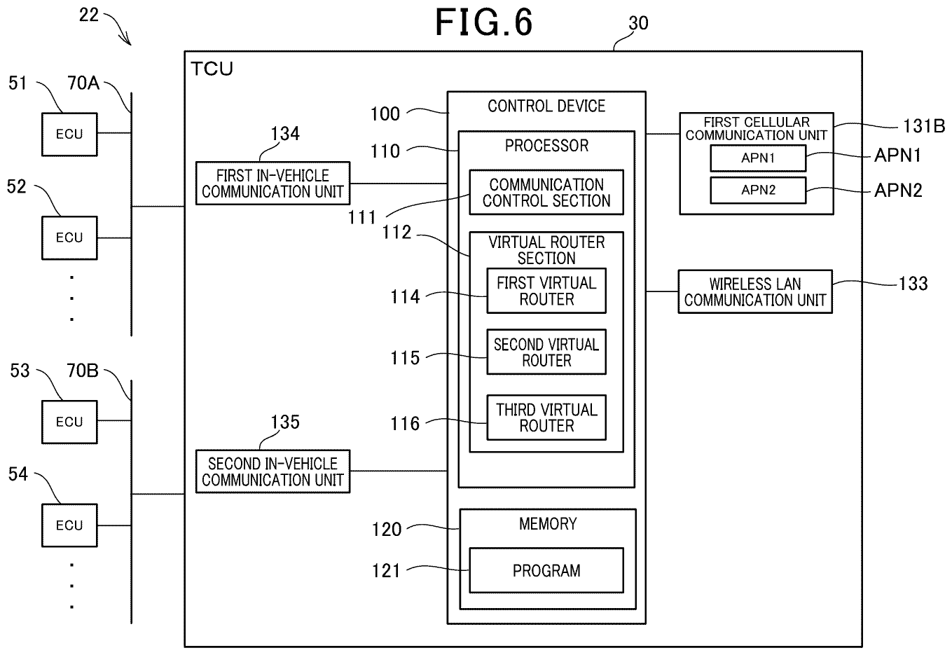

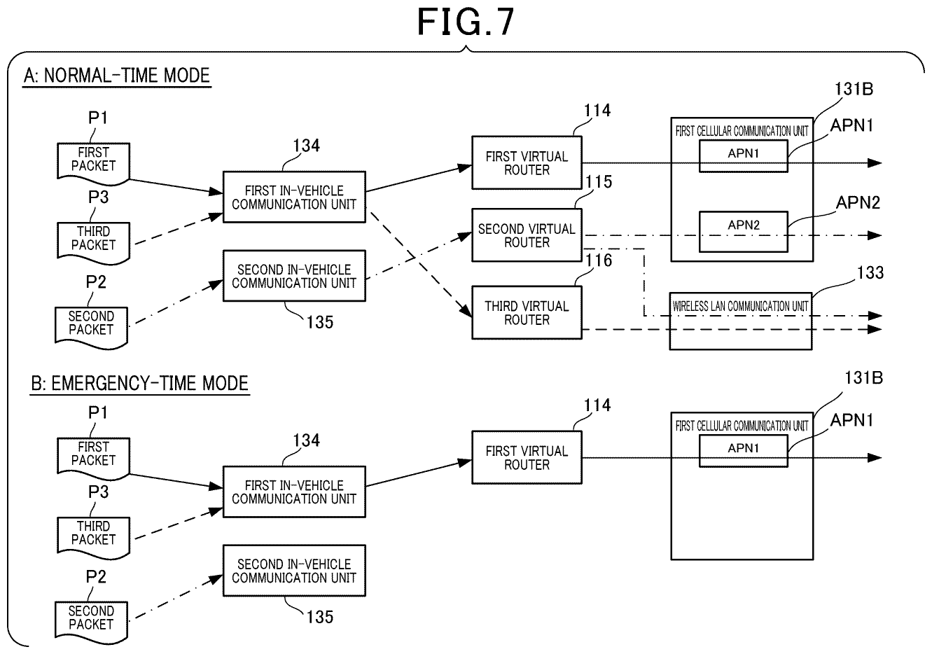

FIG. 6 schematically shows an example of system components included in a communication system 22 according to a second embodiment. FIG. 7 is an image diagram showing packet routing by a TCU 30 in the second embodiment.

As shown in FIG. 6, the TCU 30 in the second embodiment includes one cellular communication unit 131B, whereas the TCU 30 in the first embodiment includes the first cellular communication unit 131 and the second cellular communication unit 132 as two cellular communication units.

The cellular communication unit 131B is assigned APN1, APN2 that are different access point names.

As shown in FIGS. 6 and 7, a virtual router section 112, as in the first embodiment, includes a plurality of virtual routers that determines whether communications of first packets P1, second packets P2, and third packets P3 received by a communication control section 111 are to be routed to the cellular communication unit 131B, or to a wireless LAN communication unit 133. Note that routing to the cellular communication unit 131B by the virtual router section 112 includes routing to each of APN1, APN2, which are the access point names assigned to the cellular communication unit 131B.

In the second embodiment, as in the first embodiment, the communication control section 111 performs communication only through cellular communication corresponding to a specified one access point name, in the emergency-time mode.

In the emergency-time mode in the second embodiment, the communication control section 111 disables network paths to cellular communication corresponding to APN2 assigned to the cellular communication unit 131B, and stops the wireless LAN communication unit 133. As described above, in the second embodiment, the cellular communication unit 131B as an outside-communication interface is not stopped, and network paths associated with APN2 are disabled, whereby resources for communication involving APN2 are reduced.

Thus, since resources for communication between the mobile object 20 and the outside are reduced, costs for communication are reduced.

Moreover, in the emergency-time mode, the communication control section 111, as in the first embodiment, deletes the second virtual router 115 and the third virtual router 116, except the first virtual router 114 that routes cellular communications associated with APN1.

As described above, in the emergency-time mode, by the communication control section 111, only packets associated with APN1 are transmitted to the outside, as in the first embodiment. In other words, only first packets P1 related to the first service are transmitted to the outside.

Thus, in the emergency-time mode, resources for communication are limited to only those for cellular communication corresponding to APN1. Accordingly, costs for communication are reduced, and accuracy in communication is enhanced.

### 4. Operation

In operation of the TCU 30 in the second embodiment, specific details of step S3 are different from those shown in FIG. 4 in the first embodiment. In step S3 in the second embodiment, the communication control section 111 routes a communication exclusively to the first cellular communication unit 131B corresponding to APN1, disables network paths associated with APN2, stops the wireless LAN communication unit 133, allows the first virtual router 114 to operate, and deletes the second virtual router 115 and the third virtual router 116.

### 5. Other Embodiments

The above-described embodiments are only to illustrate aspects, and any modifications and applications can be made.

The first and second embodiments illustrate, as an operation in the emergency-time mode, that the second virtual router 115 and the third virtual router 116, which are the other virtual routers than the first virtual router 114, are deleted. However, embodiments are not limited thereto. As an operation in the emergency-time mode, a TCU 30 in another embodiment may delete all virtual routers and then further create another fourth virtual router. The fourth virtual router is, for example, a virtual router having similar functionality to that of the first virtual router 114. The fourth virtual router may be configured to route a fourth packet having a reduced amount of data that is even smaller than that of a first packet P1.

The first and second embodiments illustrate, as an operation in the emergency-time mode, that the second virtual router 115 and the third virtual router 116, which are the other virtual routers than the first virtual router 114, are deleted, and the other outside-communication interfaces than the first cellular communication unit 131 or the cellular communication unit 131B that handles communications associated with APN1 are stopped. However, embodiments are not limited thereto. A TCU 30 in another embodiment may be configured to perform, in the emergency-time mode, at least any one of an operation related to deleting a virtual router, and an operation related to stopping a communication function of an outside-communication interface.

In the first and second embodiments, the TCU 30 is configured to include one wireless LAN communication unit 133. However, embodiments are not limited thereto. A TCU 30 in another embodiment may include a plurality of wireless LAN communication units 133.

In the first embodiment, the TCU 30 is configured to include the first cellular communication unit 131 and the second cellular communication unit 132, and in the second embodiment, the TCU 30 is configured to include the cellular communication unit 131B. However, embodiments are not limited thereto. A TCU 30 in another embodiment may include three or more cellular communication units assigned different access point names, respectively.

Each cellular communication unit may be assigned three or more different access point names.

In the first and second embodiments, the TCU 30 is configured such that the second in-vehicle communication unit 135 performs wireless communication with the in-vehicle equipment, and the wireless LAN communication unit 133 performs wireless communication with the outside. However, embodiments are not limited thereto. A TCU 30 in another embodiment may include any one of the second in-vehicle communication unit 135 and the wireless LAN communication unit 133 as a communication interface, and the communication interface may perform wireless communication with the in-vehicle equipment and the outside. The communication interface in such a case functions as both an input-output interface connected to the in-vehicle communication network 70A, and an outside-communication interface.

In the emergency-time mode, the communication control section 111 may disable routing by any virtual router from being performed, by rewriting settings in the routing table, instead of deleting any virtual router.

The processor 110 may be configured by using a plurality of processors, or by using a single processor. The processor 110 may be hardware programmed in such a manner as to implement the above-described functional sections. In such a case, the processors are configured by using, for example, an application specific integrated circuit (ASIC) or a field programmable gate array (FPGA).

The configuration of each unit and section in the communication system 22 shown in FIG. 2 is an example, and a specific form of implementation thereof is not limited. In other words, hardware pieces respectively corresponding to the individual units and sections do not necessarily need to be mounted, and it is also naturally possible to make a configuration in which a single processor implements the functionality of the individual units and sections by executing a program. Moreover, one or some of the functions implemented by using software in the above-described embodiments may be configured as hardware, or one or some of the functions implemented by hardware may be implemented by using software.

The step units of the operation shown in FIGS. 4 and 5 are configured by division according to major processes. The present invention is not limited by the way of division into or the names of units of processing. Division may be made into more step units, depending on processes. Division may be made in such a manner that one step unit includes more processes. Moreover, order of the steps may be changed as appropriate within a scope that does not impair the gist of the present invention.

### 6. Configurations Supported by the Embodiments

The embodiments support following configurations.

### Configuration 1

A communication device provided in a mobile object, the communication device including, as outside-communication interfaces for communication with an outside of the mobile object, at least one cellular communication unit that performs cellular communication and a wireless LAN communication unit that performs wireless LAN communication, the communication device including: a plurality of virtual routers that determines whether to route a communication to the cellular communication unit, or to route a communication to the wireless LAN communication unit; and a communication control section that has a normal-time mode and an emergency-time mode, the communication control section differentiating ways of routing in the normal-time mode and the emergency-time mode from each other by controlling routing by the virtual routers, wherein in the emergency-time mode, the communication control section performs control in such a manner that a specified one of the outside-communication interfaces performs communication.

The communication device according to configuration 1, in the emergency-time mode, allows only the specified outside-communication interface to perform communication with the outside of the mobile object. Accordingly, communication can be performed with appropriate accuracy in case of emergency.

### Configuration 2

The communication device according to configuration 1, wherein the communication control section routes a communication to any one of the cellular communication unit and the wireless LAN communication unit in the normal-time mode, and routes a communication exclusively to the cellular communication unit that corresponds to specified one access point name in the emergency-time mode.

The communication device according to configuration 2, in case of emergency, reduces resources for communication and limits ways of communication to cellular communication. Accordingly, communication can be performed with more appropriate accuracy in case of emergency.

### Configuration 3

The communication device according to configuration 2, wherein the communication device includes a plurality of the cellular communication units, the cellular communication units are assigned different access point names, respectively, and in the emergency-time mode, the communication control section stops each cellular communication unit except the cellular communication unit that performs cellular communication corresponding to the specified one access point name, and also stops the wireless LAN communication unit.

The communication device according to configuration 3, in case of emergency, allows communication with the outside of the mobile object to be performed only through cellular communication corresponding to the specified one access point name. Accordingly, communication can be performed with more appropriate accuracy. Moreover, each cellular communication unit corresponding to another access point name than the specified one access point name and the wireless LAN communication unit are stopped. Accordingly, since resources for communication in the communication device are further reduced, the reliability and accuracy of communication are further enhanced.

### Configuration 4

The communication device according to configuration 2, wherein the communication device includes the one cellular communication unit, the cellular communication unit is assigned a plurality of different access point names, and in the emergency-time mode, the communication control section disables a network path associated with each access point name except the specified one access point name, and also stops the wireless LAN communication unit.

The communication device according to configuration 4, in case of emergency, allows communication with the outside of the mobile object to be performed only through cellular communication corresponding to the specified one access point name. Accordingly, communication can be performed with more appropriate accuracy. Further, network paths associated with each access point name except the specified one access point name, and the wireless LAN communication unit are stopped. Accordingly, since resources for communication in the communication device are further reduced, the reliability and accuracy of communication are further enhanced.

### Configuration 5

The communication device according to any one of configurations 2 to 5, wherein in the emergency-time mode, the communication control section allows a specified virtual router to operate and deletes each virtual router except the specified virtual router, the specified virtual router being the virtual router that determines to route a communication to the cellular communication unit corresponding to the specific one access point name.

The communication device according to configuration 5 reduces the number of virtual routers in case of emergency, whereby since resources for communication in the communication device are further reduced, the reliability and accuracy of communication are further enhanced.

### Configuration 6

A control method for a communication device provided in a mobile object, the communication device including, as outside-communication interfaces for communication with an outside of the mobile object, at least one cellular communication unit that performs cellular communication and a wireless LAN communication unit that performs wireless LAN communication, the communication device including a plurality of virtual routers that determines whether to route a communication to the cellular communication unit, or to route a communication to the wireless LAN communication unit, the control method including: a normal-time control step; and an emergency-time control step, wherein ways of routing in the normal-time control step and the emergency-time control step are differentiated from each other by routing of each communication being controlled, and in the emergency-time control step, control is performed in such a manner that a specified one of the outside-communication interfaces performs communication.

The control method according to configuration 6 brings about effects similar to those of the communication device according to configuration 1.

### Configuration 7

A non-transitory computer-readable storage medium storing a program for a communication device provided in a mobile object, the communication device including, as outside-communication interfaces for communication with an outside of the mobile object, at least one cellular communication unit that performs cellular communication and a wireless LAN communication unit that performs wireless LAN communication, the communication device including a plurality of virtual routers that determines whether to route a communication to the cellular communication unit, or to route a communication to the wireless LAN communication unit, the program causing a processor of the communication device to function as a communication control section that has a normal-time mode and an emergency-time mode, the communication control section differentiating ways of routing in the normal-time mode and the emergency-time mode from each other by controlling routing by the virtual routers, wherein in the emergency-time mode, the communication control section performs control in such a manner that a specified one of the outside-communication interfaces performs communication.

The program according to configuration 7 brings about effects similar to those of the communication device according to configuration 1.

### REFERENCE SIGNS LIST

11 wireless relay device, 12 wireless base station, 20 mobile object, 22 communication system, 30 TCU (communication device), 70A, 70B in-vehicle communication network, 90 communication network, 100 control device, 110 processor, 111 communication control section, 112 virtual router section, 114 first virtual router (virtual router), 115 second virtual router (virtual router), 116 third virtual router (virtual router), 120 memory, 121 program, 131 first cellular communication unit (cellular communication unit, outside-communication interface), 131B cellular communication unit (outside-communication interface), 132 second cellular communication unit (cellular communication unit, outside-communication interface), 133 wireless LAN communication unit (outside-communication interface), 134 first in-vehicle communication unit, 135 second in-vehicle communication unit, P1 first packet, P2 second packet, P3 third packet

1. A communication device provided in a mobile object, the communication device including, as outside-communication interfaces for communication with an outside of the mobile object, at least one cellular communication unit that performs cellular communication and a wireless LAN communication unit that performs wireless LAN communication, the communication device comprising:
a plurality of virtual routers that determines whether to route a communication to the cellular communication unit, or to route a communication to the wireless LAN communication unit; and
a communication control section that has a normal-time mode and an emergency-time mode, the communication control section differentiating ways of routing in the normal-time mode and the emergency-time mode from each other by controlling routing by the virtual routers,
wherein in the emergency-time mode, the communication control section performs control in such a manner that a specified one of the outside-communication interfaces performs communication.

2. The communication device according to claim 1, wherein the communication control section routes a communication to any one of the cellular communication unit and the wireless LAN communication unit in the normal-time mode, and routes a communication exclusively to the cellular communication unit that corresponds to specified one access point name in the emergency-time mode.

3. The communication device according to claim 2, wherein
the communication device comprises a plurality of the cellular communication units,
the cellular communication units are assigned different access point names, respectively, and
in the emergency-time mode, the communication control section stops each cellular communication unit except the cellular communication unit that performs cellular communication corresponding to the specified one access point name, and also stops the wireless LAN communication unit.

4. The communication device according to claim 2, wherein
the communication device comprises the one cellular communication unit,
the cellular communication unit is assigned a plurality of different access point names, and
in the emergency-time mode, the communication control section disables a network path associated with each access point name except the specified one access point name, and also stops the wireless LAN communication unit.

5. The communication device according to claim 2, wherein in the emergency-time mode, the communication control section allows a specified virtual router to operate and deletes each virtual router except the specified virtual router, the specified virtual router being the virtual router that determines to route a communication to the cellular communication unit corresponding to the specific one access point name.

6. A control method for a communication device provided in a mobile object, the communication device including, as outside-communication interfaces for communication with an outside of the mobile object, at least one cellular communication unit that performs cellular communication and a wireless LAN communication unit that performs wireless LAN communication, the communication device including a plurality of virtual routers that determines whether to route a communication to the cellular communication unit, or to route a communication to the wireless LAN communication unit, the control method comprising:
a normal-time control step; and
an emergency-time control step, wherein
ways of routing in the normal-time control step and the emergency-time control step are differentiated from each other by routing of each communication being controlled, and
in the emergency-time control step, control is performed in such a manner that a specified one of the outside-communication interfaces performs communication.

7. A non-transitory computer-readable storage medium storing a program for a communication device provided in a mobile object, the communication device including, as outside-communication interfaces for communication with an outside of the mobile object, at least one cellular communication unit that performs cellular communication and a wireless LAN communication unit that performs wireless LAN communication, the communication device including a plurality of virtual routers that determines whether to route a communication to the cellular communication unit, or to route a communication to the wireless LAN communication unit, the program causing a processor of the communication device to function as
a communication control section that has a normal-time mode and an emergency-time mode, the communication control section differentiating ways of routing in the normal-time mode and the emergency-time mode from each other by controlling routing by the virtual routers,
wherein in the emergency-time mode, the communication control section performs control in such a manner that a specified one of the outside-communication interfaces performs communication.
